(19) United States
(12) Patent Application Publication
(10) Pub. No.: US 2025/0260330 A1
(43) Pub. Date: Aug. 14, 2025

(54) POWER CONVERTER AND SYSTEM INCLUDING A POWER CONVERTER, AND METHOD OF OPERATING THE SAME

(71) Applicant: Infineon Technologies Austria AG, Villach (AT)

(72) Inventors: Yi ZHANG, Shenzhen (CN); Sanbao SHI, Shenzhen (CN); Cheng ZHANG, Shenzhen (CN)

(21) Appl. No.: 19/020,645

(22) Filed: Jan. 14, 2025

(30) Foreign Application Priority Data
Feb. 9, 2024 (DE) 102024103740.7

(51) Int. Cl. H02M 3/335; H02M 1/00; H02M 1/36

(52) U.S. Cl. CPC H02M 3/33584; H02M 1/0006; H02M 1/0009; H02M 1/36

(57) ABSTRACT

A power converter is provided, including a first primary side circuit including a first input configured to receive a first input voltage, a first primary side winding of a transformer, and a first switch coupled between the first input and the first primary side winding, a second primary side circuit including a second input configured to receive a second input voltage, a second primary side winding of the transformer, and a second switch coupled between the second input and the first primary side winding, and a secondary side winding of the transformer coupled to an output of the power converter, wherein the first switch and the second switch are configured to be switched concurrently.

### CROSS-REFERENCE TO RELATED APPLICATION

This application claims priority to Germany Patent Application No. 102024103740.7 filed on Feb. 9, 2024, the content of which is incorporated by reference herein in its entirety.

### TECHNICAL FIELD

The present application relates to power converters and to systems including such power converters and methods of operating the same.

### BACKGROUND

Power converters are devices which convert an input electrical power to an output electrical power. For example, a power converter may convert an input voltage to an output voltage. The output voltage may have a predefined magnitude suitable for a particular application.

In some applications, power converters are also used in a system to provide power for a controller of a further power converter. For example, the supply voltage for the controller may be generated based on an input voltage of the further power converter.

Some power converters may be bidirectional power converters, where each side of the power converter may serve as an input or as an output. In this case, providing a supply for a controller of such a power converter may be a challenge as the input voltage may be provided at either side.

### SUMMARY

A power converter as defined in claim 1, a system as defined in claim 12 and a method as defined in claim 13 are provided. The dependent claims define further implementations.

According to an implementation, a power converter is provided, including: a first primary side circuit including a first input configured to receive a first input voltage, a first primary side winding of a transformer, and a first switch (Q1) coupled between the first input and the first primary side winding, a second primary side circuit including a second input configured to receive a second input voltage, a second primary side winding of the transformer, and a second switch (Q2) coupled between the second input and the second primary side winding, and a secondary side winding of the transformer coupled to an output of the power converter, wherein the first switch (Q1) and the second switch (Q2) are configured to be switched concurrently. For example, a controller may be provided configured to switch the first switch (Q1) and the second switch (Q2) concurrently.

According to another implementation, a system is provided, including: a bidirectional power converter having a first terminal and a second terminal, wherein the bidirectional power converter is configured to selectively generate a second voltage at the second terminal based on a first voltage at the first terminal or generate the first voltage at the first terminal based on the second voltage at the second terminal, a bidirectional power converter controller configured to control the bidirectional power converter, and the power converter as mentioned above, wherein the first input of the power converter is coupled to the first terminal, a second input of the power converter to the second terminal, and the output of the power converter is coupled to a supply terminal of the bidirectional power converter controller.

According to a further implementation, a method is provided, including: providing a power converter as mentioned above, and operating the first switch (Q1) and the second switch (Q2) of the power converter concurrently to generate an output voltage at an output of the power converter.

The above summary merely gives a brief overview over some implementations and is not to be construed as limiting in any way, as other implementations may include different features than the ones explained above.

### BRIEF DESCRIPTION OF THE DRAWINGS

FIG. 1 is a circuit diagram of a power converter according to an implementation.

FIG. 2 is a schematic diagram of a controller for the power converter of FIG. 1.

FIG. 3 shows example signals of the power converter of FIG. 1 and the controller of FIG. 2.

FIG. 4 is a block diagram of a system according to an implementation.

FIGS. 5A and 5B are circuit diagrams illustrating supply of a controller of a power converter according to an implementation.

FIGS. 6A to 6D illustrate circuit diagrams for initially supplying a controller of a power converter according to some implementations.

FIGS. 7A and 7B are circuit diagrams illustrating generation of a current sense signal according to some implementations.

FIG. 8 is a flowchart illustrating a method according to an implementation.

### DETAILED DESCRIPTION

In the following, various implementations, which are not to be construed as limiting, will be described referring to the attached drawings.

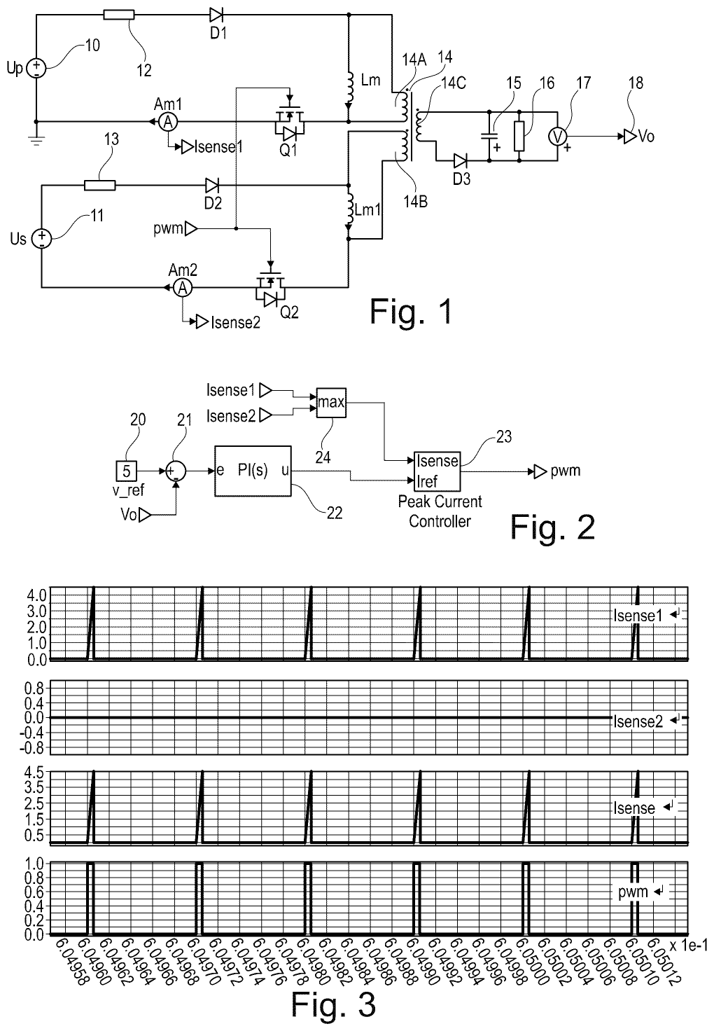

Implementations described in the following relate to power converters which may receive two different input voltages to generate an output voltage. For example, in the implementation of FIG. 1, the power converter shown may receive a first input voltage Up, a second input voltage Us, or both a first input voltage Up and a second input voltage Us, to generate an output voltage Vo. In other words, when the power converter of FIG. 1 is operated to generate the output voltage Vo, both Up and Us may be present, or only one of Up or Us may be present.

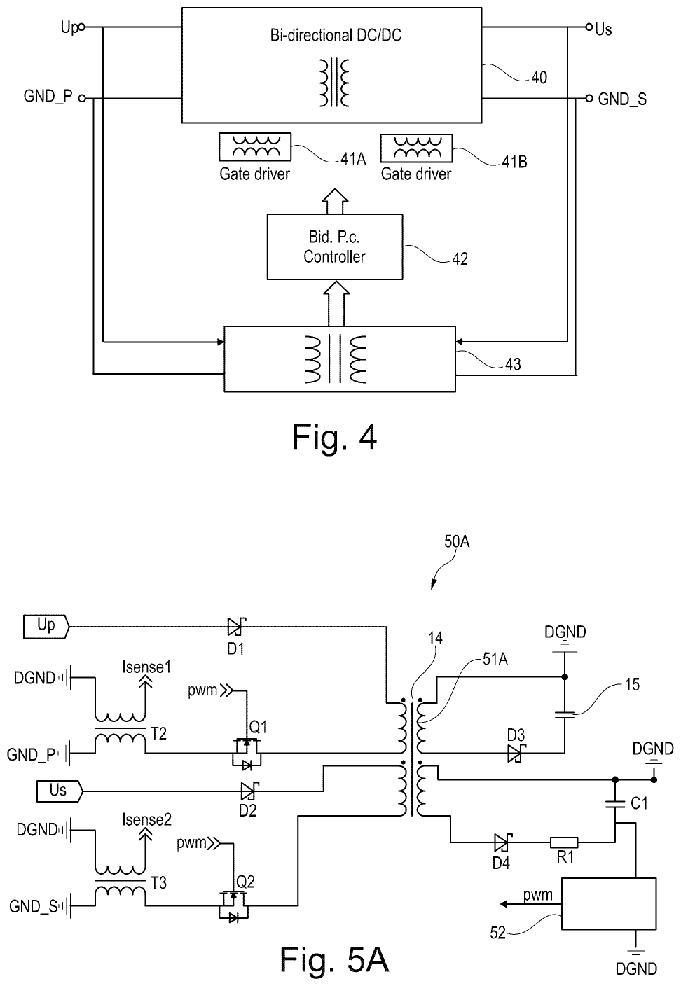

First input voltage Up is symbolized as being generated by a voltage source 10, and second input voltage Us is symbolized as being generated by a voltage source 11. Voltage sources 10, 11 may be representing any kind of circuit delivering the respective voltage. In some instances, as will be explained further below for FIG. 4, input voltages Up and Us may be voltages on two different sides of a bidirectional power converter.

First input voltage Up is received by a first primary side circuit including a resistor 12, a diode D1, a first primary side winding 14A of a transformer 14, and a first switch Q1, in the implementation of FIG. 1 implemented as a field effect transistor switch having a body diode. Resistor 12 may be a resistor explicitly provided, may represent internal resistances of other circuit elements (e.g., the electrical connections shown), or may be omitted.

Furthermore, an inductor Lm is explicitly shown, which in many flyback converter implementations is realized by an airgap in a core of transformer 14 and which is the main inductor for storing energy in the first primary side circuit. As this inductor Lm is usually implemented in transformer 14 (e.g., by providing an airgap), it will not be explicitly shown in implementations discussed further below. To measure a current Isense1 in the first primary side circuit, a current measurement device Am1 is provided. For current measurement, any conventional technique may be used, for example measuring a voltage drop across a low-ohmic resistor, using an inductive measurement or using a magnetoresistive measurement capturing a magnetic field generated by the current, the latter two providing a galvanic isolation to the measurement, which may be desirable in some implementations.

Second input voltage Us is provided to a second primary side circuit, which comprises a resistor 13, a diode D2, a second primary side winding 14B of transformer 14, a second switch Q2, and an inductor Lm1. Furthermore, a current measurement device Am2 for measuring a current Isense2 in the second primary side circuit is provided. The second primary side circuit may be implemented corresponding to the first primary side circuit, and the explanations regarding the various elements for the first primary side circuit also apply to the corresponding elements of the second primary side circuit.

Furthermore, the power converter of FIG. 1 comprises a secondary side circuit including a secondary side winding 14C of transformer 14, an output capacitor 15 across which an output voltage Vo is provided, and an output resistor 16 symbolizing a load receiving the output voltage Vo. On the secondary side, a voltage sensor 17 may capture the output voltage Vo and output a measured Vo at a terminal 18. The measured output voltage Vo may be used for controlling the power converter of FIG. 1, e.g., for regulating the output voltage Vo to a target output voltage. While in FIG. 1 a single secondary side circuit is shown, in other implementations a plurality of secondary side circuits may be provided, to provide a plurality of output voltages.

The power converter of FIG. 1 essentially is a flyback converter which, however, has two primary side circuits. In the implementation of FIG. 1, switch Q1 of the first primary side circuit and switch Q2 of the second primary side circuit are configured to be operated concurrently (e.g., switched on and off essentially at the same time), for example, as shown in FIG. 1, configured to receive the same control signal pwm. In implementations, control signal pwm is generated by a controller based on a feedback from the secondary side circuit indicating the output signal Vo and based on the currents Isense1, Isense2. An example implementation of a controller for the power converter of FIG. 1 is shown in FIG. 2. The control signal pwm may be a pulse width modulation (PWM) signal.

The controller depicted in FIG. 2 receives the output signal Vo or any indication thereof (for example indication via an optocoupler if the controller is provided on the primary side) and subtracts the output signal Vo from a reference voltage Vref provided in a block 20. The reference voltage Vref is the voltage the power converter is intended to output. One or more proportional/integral (PI) controllers 22 process the output of subtractor 20 to generate a reference value Iref. Other types of controllers instead of PI controllers 22 may also be used, e.g., type I compensators, type II compensators or type III compensators. Furthermore, the maximum of Isense1 and Isense2 is formed by a block 24 to generate a value Isense. Isense and Iref are processed by a current controller 23 to generate signal pwm controlling switches Q1, Q2. Apart from processing two measured currents Isense1, Isense2 from two primary side circuits the controller may essentially operate like any conventional flyback controller, and apart from the peak current control illustrated in FIG. 2 other conventional flyback controller schemes may also be used. For example, the power converter may be implemented as a quasi-resonant flyback converter, and corresponding control schemes may be used for driving switches Q1 and Q2, in case of an implementation as transistors gate drivers may be used to drive the switches in accordance with signal pwm. Such gate drivers may include a galvanic isolation (e.g., via a transformer) if the controller is referenced to a different ground than the switch to be driven (e.g., if the controller is on the secondary side of the power converter of FIG. 1).

FIG. 3 shows simulated example signals for Isense1, Isense2, Isense and pwm in an example operation. Here, only a current Isense1 flows, whereas Isense2 is zero. Generally, although the two switches Q1, Q2 are commonly controlled, current will flow in only one of the primary side circuits in the implementation of FIG. 1, depending on a ratio R=Up/Us between the first input voltage Up and the second input voltage Us and a turns ratio RT between primary side windings 14A, 14B. Assuming that RT=1 (equal number of turns in windings 14A and 14B), if Up>Us (R>1), then D1 will conduct, and through transformer 14 the voltage Up will be mirrored to the second primary side winding, leading diode D2 to block. Conversely, if Us>Up (R<1), D2 conducts and D1 will be blocking. In the first case (Up>Us) power to the secondary side circuit and to the output voltage Vo will be supplied via the first primary side circuit, e.g., supplied by Up, and in the second case conversely the output voltage will be supplied by Us. If RT≠1, the above situation is modified by the turns ratio, e.g., then the ratio R determining whether power is supplied from the first or second primary side circuit is equal to (Up/Us)*RT.

For example, in the simulation result of FIG. 3, Up is higher than Us, and therefore Isense1 can flow, but not Isense2. If Up is equal to Us and RT=1 (or, more generally, when the above ratio R=1), power will be supplied to the secondary side both from the first primary side circuit and from the second primary side circuit.

The power converter of FIG. 1 may for example be used to supply power to a controller of a bidirectional power converter, referred to as bidirectional power converter controller in the following. This is only an example, and the power converter may alternatively or additionally also be used to supply power to other components, for example fans or relays. FIG. 4 shows a corresponding system. The system of FIG. 4 comprises a bidirectional DC/DC converter 40 as a bidirectional power converter, which converts between a first voltage Up with respect to ground GND_P and a second voltage Us with respect to a respective ground GND_S. In other words, either Up or Us may serve as an input voltage, and be converted to the respective other voltage by bidirectional DC/DC power converter 40. Bidirectional DC/DC power converter 40 is controlled by a bidirectional power converter controller 42, which may for example control gate drivers 41A, 41B driving switches of bidirectional DC/DC power converter 40. Bidirectional DC/DC power converter 40 may be implemented in any conventional manner.

Bidirectional power converter controller 42 is supplied with power by a power converter 43 according to an implementation, for example the power converter illustrated in FIG. 1, where based on the first input voltage Up or the second input voltage Us the output voltage Vo is generated, which in the example of FIG. 4 then supplies power to bidirectional power converter controller 43. In conventional solutions two power converters are needed for supplying power to bidirectional power converter controller 42. In such a conventional solution, a first power converter is required to provide power to the bidirectional power converter controller when the bidirectional converter is operated in a first direction, e.g., Up->Us, where the first power converter is powered from the same input voltage Up, and a second power converter is required to provide power to the bidirectional power converter controller when the bidirectional converter is operated in the second direction, e.g., Us->Up, where the second power converter is powered from the same input voltage Us. In contrast thereto, in the implementation of FIG. 1 only a single power converter having two primary side circuits is needed.

Moreover, as in the power converter of FIG. 1 switches Q1, Q2 are controlled concurrently, no separate control circuitry for two power converters is needed. For power converters according to implementations discussed herein, only one control loop for controlling this power converter generating a single control signal pwm is needed, which reduces the complexity of control of the power converter.

Next, some possible implementation details for the power converter of FIGS. 1 and 2 are described. While these implementation details show specific circuit implementations, other implementations may also be used.

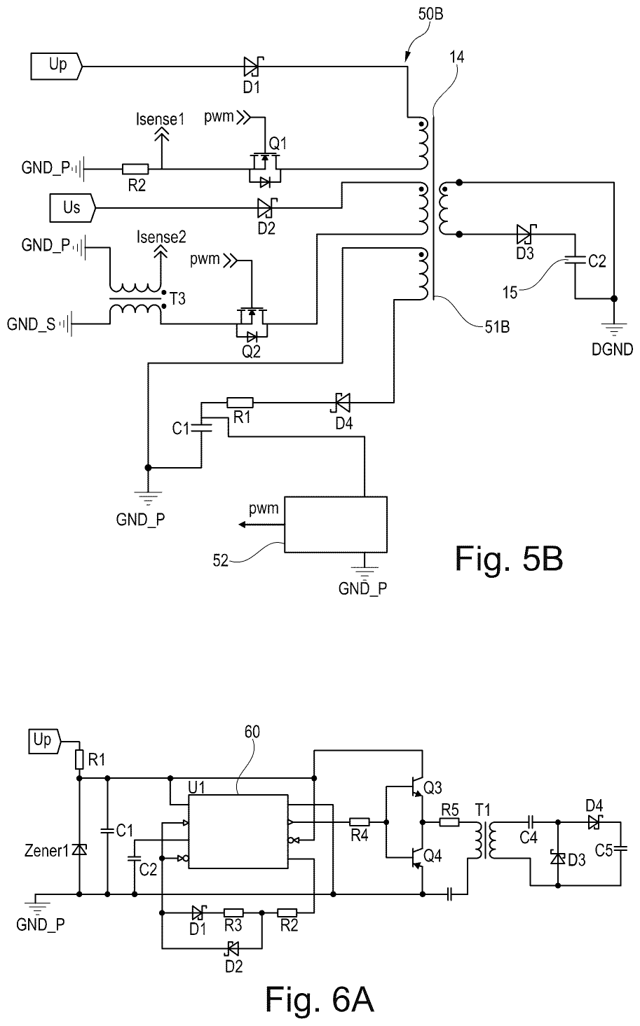

FIGS. 5A and 5B illustrate examples for supplying power to a controller 52 for the power converter of FIG. 1, for example the controller shown in FIG. 2. It should be noted that this controller 52 is not to be confused with controller 42 of FIG. 4. Bidirectional power converter controller 42 of FIG. 4 controls bidirectional DC/DC power converter 40 of FIG. 4, while the controller shown in FIG. 2 controls the power converter of FIG. 1 or for example power converter 43 of FIG. 4.

In the examples of FIG. 5A and FIG. 5B, controller 52 for a power converter 50A or 50B, which essentially correspond to the power converter of FIG. 1, is supplied with power via an auxiliary winding of transformer 14. In FIGS. 5A and 5B, auxiliary winding 51 is provided on the primary side of transformer 14 and is coupled in a loop with a diode D4, a resistor R1 and a capacitor C1 as shown. A supply voltage for the controller is provided at capacitor C1 in each case.

FIG. 5A shows an example where controller 52 is provided at the output side referenced to the output ground DGND. An auxiliary winding 51A is provided at the secondary side of transformer 14 and is coupled in a loop with a diode D4, a resistor R1 and a capacitor C1 as shown. A supply voltage for controller 52 with respect to DGND is provided at capacitor C1. Controller 52 may be implemented as shown in FIG. 2 and receive Isense1, Isense2 and Vo to generate control signal pwm for first and second switches Q1, Q2.

In this case, the current measurement of Isense1 and Isense2 may be made using a galvanic isolation to the primary side, in the example of FIG. 5A using transformers T2, T3, where Isense1 and Isense2 are tapped on a secondary side. GND_P indicates the ground of the first primary side circuit, and GND_S refers to the ground of the second primary side circuit. In case input and output is referenced to the same ground, no such galvanic isolation for current measurements is needed.

In case of FIG. 5B, the controller is provided on the primary side referenced to ground GND_P of the first primary side circuit. In this case, an auxiliary winding 51B is provided at the primary side of transformer 14 and, similar to auxiliary winding 51A of FIG. 5A, coupled in a loop with diode D4, resistor R1 and capacitor C1 as shown. Controller 52 is supplied with power by a voltage at capacitor 51 against GND_P. In this case, for measuring Isense1, a simple measurement resistor R2 may be used, whereas for Isense2 still a transformer is used where in this case the secondary winding is referenced to GND_P.

It should be noted that in other implementations, the controller for the power converter of FIG. 1 or power converter 50A, 50B may be supplied with power by some other power source in a corresponding system.

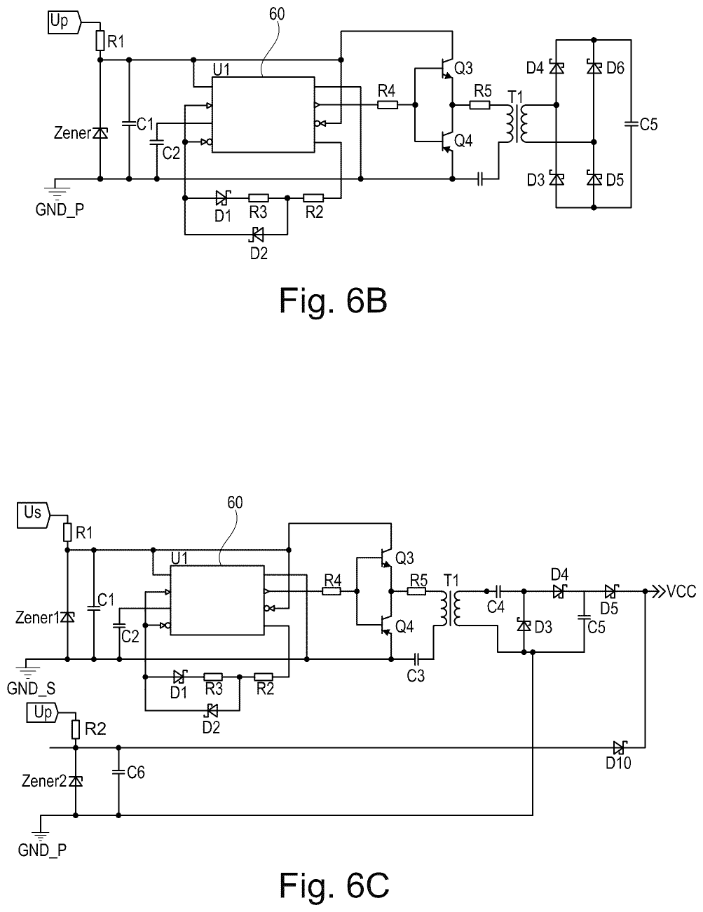

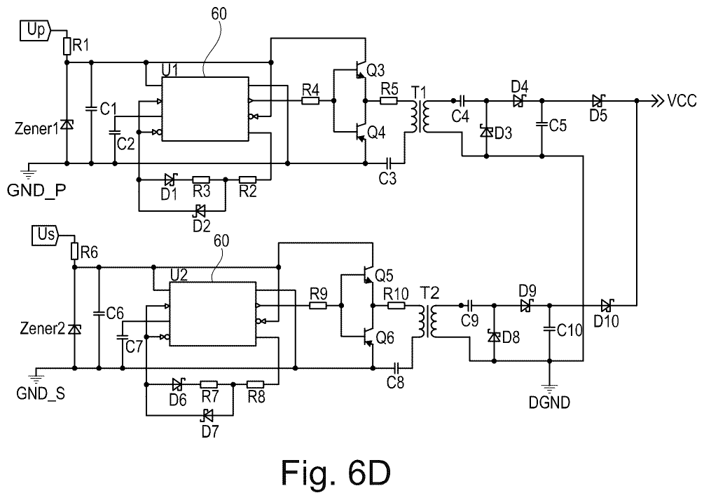

When supplying power to the controller via auxiliary winding 51A or 51B, the power converter has to operate to provide power to the controller, and for the power converter to operate, the controller requires power to control the power converter accordingly. Thus, the circuits including auxiliary winding 51A or 51B provide a power supply after startup. Additional start-up circuitry may be provided which provides an isolated power supply at start-up for the controller. Examples for such isolated power supplies are shown in FIGS. 6A to 6D.

FIGS. 6A and 6B show examples of power supply circuits for generating an output power at a respective output capacitor C5, where the implementations of FIGS. 6A and 6B differ in a rectification provided on a secondary side. A respective transformer T1 provides galvanic isolation. The power supply circuits are controlled by a control chip 60. Control chip 60 is a time chip configured to generate the control signal pwm with a desired frequency.

The power supply circuits of FIGS. 6A and 6B rely on Up as an input power. In case of a bidirectional power converter system as in FIG. 4, at start-up either Up or Us may be present. In this case, as shown in FIGS. 6C and 6D, for start-up, a power supply circuit may be provided which may operate on both Us and Up.

FIG. 6C shows an example where the power converter is provided referenced to GND_P of Up (similar to the situation of FIG. 5B). In this case, no isolation is needed for Up, but for Us a circuit as in FIG. 6A or 6B is provided as a power supply circuit. The two parts are then matched such that their outputs are added. FIG. 6D shows a case where the power controller is provided at the output side (similar to the situation of FIG. 5A, may be combined with the power supply of FIG. 5A), where circuits as in FIGS. 6A and 6B are provided for both Up and Us. In FIG. 6C, the controller will be supplied with power by the higher one of the voltages at C6 and C5, and in FIG. 6D the controller will be supplied with power by the higher one of voltages at C5 and C10. Note that the circuits of FIGS. 6A to 6D are configured to supply power at the start-up when there is still a light load condition, and later in operation the supply may be provided via an auxiliary winding as explained with references to FIGS. 5A and 5B.

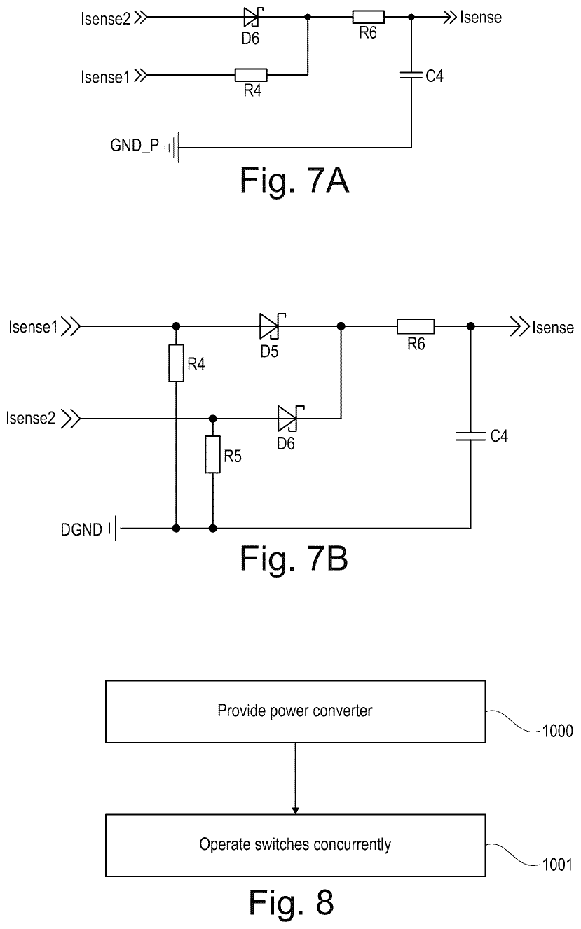

FIGS. 7A and 7B show two example circuits how signals Isense1, Isense2 may be added to arrive at signal Isense. The circuit of FIG. 7A may be used when the controller is at the first primary side circuit referenced to GND_P. In this case, the signal Isense2 is provided via a diode, and the signal Isense1 is provided directly to generate Isense. FIG. 7B shows an example where the controller is at the secondary side, where both Isense1 and Isense2 are tapped using a galvanic isolation, as shown in FIG. 5A. Other circuits for generating Isense may also be used.

FIG. 8 is a flowchart of a method according to an implementation.

At 1000, the method comprises providing a power converter, for example as shown in FIG. 1, having a first primary side circuit including a first switch (Q1) and a first primary side circuit and a second switch (Q2) in the second primary side circuit. At 1001, the method comprises operating the first switch (Q1) and the second switch (Q2) concurrently, as explained above for the power converter of FIG. 1.

### ASPECTS

Some implementations are defined by the following aspects:

Aspect 1: A power converter, comprising: a first primary side circuit comprising a first input configured to receive a first input voltage, a first primary side winding of a transformer, and a first switch coupled between the first input and the first primary side winding, a second primary side circuit comprising a second input configured to receive a second input voltage, a second primary side winding of the transformer, and a second switch coupled between the second input and the second primary side winding, and a secondary side winding of the transformer coupled to an output of the power converter, wherein the first switch and the second switch are configured to be switched concurrently.

Aspect 2: The power converter of aspect 1, wherein the first primary side circuit comprises a first diode coupled between the first input and the first primary side winding, and the second primary side circuit comprises a second diode coupled between the second input and the second primary side winding.

Aspect 3: The power converter of aspect 1 or 2, further comprising a controller configured to switch the first switch and the second switch concurrently.

Aspect 4: The power converter of aspect 3, further comprising: a first current sensor configured to measure a first current in the first primary side circuit, a second current sensor configured to measure a second current in the second primary side circuit, wherein the controller is configured to control the first switch and the second switch based on the first current and the second current.

Aspect 5: The power converter of aspect 4, wherein at least one of the first current sensor or the second current sensor comprises a galvanic isolation.

Aspect 6: The power converter of aspect 4 or 5, wherein the controller is configured to control the first switch and the second switch further based on a voltage at the output of the power converter.

Aspect 7: The power converter of any one of aspects 3 to 6, further comprising an auxiliary winding of the transformer provided at one of the primary side of the transformer or the secondary side of the transformer, wherein the auxiliary winding is coupled to a supply input of the controller.

Aspect 8: The power converter of any one of aspects 3 to 7, further comprising a startup power supply circuit configured to supply power to the controller at startup based on one of the first input voltage or the second input voltage.

Aspect 9: The power converter of aspect 8, wherein the startup power supply circuit comprises a galvanic isolation.

Aspect 10: The power converter of aspect 8 or 9, wherein the startup power supply circuit is configured to supply power to the controller at startup based on the higher one of the first input voltage and the second input voltage.

Aspect 11: The power converter of any one of aspects 3 to 10, wherein the power converter is configured to drive the first switch and/or the second switch via a galvanic isolation.

Aspect 12: A system, comprising: a bidirectional power converter having a first terminal and a second terminal, wherein the bidirectional power converter is configured to selectively generate a second voltage at the second terminal based on a first voltage at the first terminal, or generate the first voltage at the first terminal based on the second voltage at the second terminal, a bidirectional power converter controller configured to control the bidirectional power converter, the power converter of any one of aspects 1 to 11, wherein the first input of the power converter is coupled to the first terminal, the second input of the power converter is coupled to the second terminal, and the output of the power converter is coupled to a supply terminal of the bidirectional power converter controller.

Aspect 13: A method, comprising: providing the power converter of any one of aspects 1 to 11, and operating the first switch and the second switch concurrently to generate an output voltage at an output of the power converter.

Aspect 14: The system of Aspect 12, wherein the bidirectional power converter is a bidirectional DC/DC converter.

Aspect 15: The system of Aspect 12, wherein the first primary side circuit comprises a first diode coupled between the first input and the first primary side winding, and wherein the second primary side circuit comprises a second diode coupled between the second input and the second primary side winding.

Aspect 16: The system of Aspect 12, further comprising: a controller configured to switch the first switch and the second switch concurrently such that the first switch and the second switch are switched on substantially at the same time, and such that the first switch and the second switch are switched off substantially at the same time.

Aspect 17: The system of Aspect 16, further comprising: a first current sensor configured to measure a first current in the first primary side circuit, a second current sensor configured to measure a second current in the second primary side circuit, wherein the controller is configured to control the first switch and the second switch based on a measurement of the first current and a measurement of the second current provided by the first current sensor and the second current sensor, respectively.

Aspect 18: The system of Aspect 17, wherein at least one of the first current sensor or the second current sensor comprises a galvanic isolation.

Aspect 19: The system of Aspect 17, wherein the controller is configured to control the first switch and the second switch further based on a voltage at the output of the power converter.

Aspect 20: The system of Aspect 16, further comprising: an auxiliary winding of the transformer provided at one of the primary side of the transformer or the secondary side of the transformer, wherein the auxiliary winding is coupled to a supply input of the controller.

Although specific implementations have been illustrated and described herein, it will be appreciated by those of ordinary skill in the art that a variety of alternate and/or equivalent implementations may be substituted for the specific implementations shown and described without departing from the scope of the present implementation. This application is intended to cover any adaptations or variations of the specific implementations discussed herein. Therefore, it is intended that this implementation be limited only by the claims and the equivalents thereof.

1. A power converter, comprising:
a first primary side circuit comprising a first input configured to receive a first input voltage, a first primary side winding of a transformer, and a first switch coupled between the first input and the first primary side winding;
a second primary side circuit comprising a second input configured to receive a second input voltage, a second primary side winding of the transformer, and a second switch coupled between the second input and the second primary side winding; and
a secondary side winding of the transformer coupled to an output of the power converter,
wherein the first switch and the second switch are configured to be switched concurrently.

2. The power converter of claim 1, wherein the first primary side circuit comprises a first diode coupled between the first input and the first primary side winding, and
wherein the second primary side circuit comprises a second diode coupled between the second input and the second primary side winding.

3. The power converter of claim 1, further comprising:
a controller configured to switch the first switch and the second switch concurrently.

4. The power converter of claim 3, further comprising:
a first current sensor configured to measure a first current in the first primary side circuit,
a second current sensor configured to measure a second current in the second primary side circuit,
wherein the controller is configured to control the first switch and the second switch based on a measurement of the first current and a measurement of the second current provided by the first current sensor and the second current sensor, respectively.

5. The power converter of claim 4, wherein at least one of the first current sensor or the second current sensor comprises a galvanic isolation.

6. The power converter of claim 4, wherein the controller is configured to control the first switch and the second switch further based on a voltage at the output of the power converter.

7. The power converter of claim 3, further comprising:
an auxiliary winding of the transformer provided at one of the primary side of the transformer or the secondary side of the transformer, wherein the auxiliary winding is coupled to a supply input of the controller.

8. The power converter of claim 3, further comprising:
a startup power supply circuit configured to supply power to the controller at startup of the power converter based on one of the first input voltage or the second input voltage.

9. The power converter of claim 8, wherein the startup power supply circuit comprises a galvanic isolation.

10. The power converter of claim 8, wherein the startup power supply circuit is configured to supply power to the controller at startup of the power converter based on the higher one of the first input voltage and the second input voltage.

11. The power converter of claim 3, wherein the power converter is configured to drive at least one of the first switch or the second switch via a galvanic isolation.

12. A system, comprising:
a bidirectional power converter having a first terminal and a second terminal, wherein the bidirectional power converter is configured to selectively generate a second voltage at the second terminal based on a first voltage at the first terminal, or generate the first voltage at the first terminal based on the second voltage at the second terminal;
a bidirectional power converter controller configured to control the bidirectional power converter; and
a power converter comprising:
a first primary side circuit comprising a first input configured to receive a first input voltage, a first primary side winding of a transformer, and a first switch coupled between the first input and the first primary side winding;
a second primary side circuit comprising a second input configured to receive a second input voltage, a second primary side winding of the transformer, and a second switch coupled between the second input and the second primary side winding; and
a secondary side winding of the transformer coupled to an output of the power converter,
wherein the first switch and the second switch are configured to be switched concurrently,
wherein the first input of the power converter is coupled to the first terminal, the second input of the power converter is coupled to the second terminal, and the output of the power converter is coupled to a supply terminal of the bidirectional power converter controller.

13. A method, comprising:
providing the power converter, the power converter comprising:
a first primary side circuit comprising a first input configured to receive a first input voltage, a first primary side winding of a transformer, and a first switch coupled between the first input and the first primary side winding;
a second primary side circuit comprising a second input configured to receive a second input voltage, a second primary side winding of the transformer, and a second switch coupled between the second input and the second primary side winding; and
a secondary side winding of the transformer coupled to an output of the power converter,
wherein the first switch and the second switch are configured to be switched concurrently; and
operating the first switch and the second switch concurrently to generate an output voltage at an output of the power converter.

14. The system of claim 12, wherein the bidirectional power converter is a bidirectional DC/DC converter.

15. The system of claim 12, wherein the first primary side circuit comprises a first diode coupled between the first input and the first primary side winding, and
wherein the second primary side circuit comprises a second diode coupled between the second input and the second primary side winding.

16. The system of claim 12, further comprising:
a controller configured to switch the first switch and the second switch concurrently such that the first switch and the second switch are switched on substantially at the same time, and such that the first switch and the second switch are switched off substantially at the same time.

17. The system of claim 16, further comprising:
a first current sensor configured to measure a first current in the first primary side circuit,
a second current sensor configured to measure a second current in the second primary side circuit,
wherein the controller is configured to control the first switch and the second switch based on a measurement of the first current and a measurement of the second current provided by the first current sensor and the second current sensor, respectively.

18. The system of claim 17, wherein at least one of the first current sensor or the second current sensor comprises a galvanic isolation.

19. The system of claim 17, wherein the controller is configured to control the first switch and the second switch further based on a voltage at the output of the power converter.

20. The system of claim 16, further comprising:
an auxiliary winding of the transformer provided at one of the primary side of the transformer or the secondary side of the transformer, wherein the auxiliary winding is coupled to a supply input of the controller.
